(19) United States
(12) Patent Application Publication
(10) Pub. No.: US 2009/0254387 A1
(43) Pub. Date: Oct. 8, 2009

(54) TECHNIQUE FOR PERFORMING TRIPLE BOTTOM-LINE ASSESSMENTS

(75) Inventors: Sean M. Daken, Boulder, CO (US); Christine S. Chen, Santa Clara, CA (US); Stanley E. Taylor, San Jose, CA (US); Froilan Rosqueta, San Francisco, CA (US); Barrie Levinson, Portland, OR (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/061,040

(22) Filed: Apr. 2, 2008

(51) Int. Cl. G06Q 40/00

(52) U.S. Cl. 705/7; 705/30; 705/31

(57) ABSTRACT

Embodiments of a computer system for determining a social responsibility metric are described. During operation, the computer system aggregates information associated with financial transactions of a user to determine the social responsibility metric. Note that the financial transactions may be included in a data structure associated with financial software, and the data structure may be stored in a computer-readable medium. Next, the computer system may provide the social responsibility metric to the user.

### BACKGROUND

The present invention relates to user interfaces and techniques for determining a social responsibility metric for one or more financial transactions.

Because of the changes associated with globalization and global warming, social and environmental sustainability are increasingly important issues. Moreover, as evidenced by the growing market for lifestyles of health and sustainability (which include goods and services that appeal to consumers who value health, the environment, social justice, personal development and sustainable living), many individuals, organizations, and businesses (henceforth referred to as ‘entities’) are willing to purchase goods and services that offer increased sustainability. In principle, these entities would like to extend this social and environmental responsibility to other aspects of their lives or operations.

Unfortunately, entities often lack the tools and the associated information needed to make informed decisions. For example, current financial management is often focused on profit and loss as a metric for the overall prosperity of an entity. However, this approach often neglects the impact or consequences of the entity's actions on other individuals and/or the environment. Consequently, it is currently difficult for entities to be more socially and environmentally responsible.

### SUMMARY

One embodiment of this invention provides a computer system for determining a social responsibility metric. During operation, the computer system aggregates information associated with financial transactions of a user to determine the social responsibility metric. Note that the financial transactions may be included in a data structure associated with financial software, and the data structure may be stored in a computer-readable medium. Next, the computer system may provide the social responsibility metric to the user.

In some embodiments, providing the social responsibility metric to the user involves displaying the social responsibility metric.

In some embodiments, the user includes an individual, an organization, a corporation, and/or an entity.

In some embodiments, the social responsibility metric includes an estimated carbon footprint associated with the financial transactions. Moreover, based on the estimated carbon footprint, the computer system may receive a request to purchase a carbon-offset credit.

In some embodiments, the social responsibility metric is based on an impact of the financial transactions on the environment (such as associated amount of pollution) and/or on other people (such as products that are produced at factories with poor work conditions). Moreover, the social responsibility metric may be based on a profit assessment of the user.

In some embodiments, the computer system provides recommendations to the user on ways to improve the social responsibility metric. For example, the recommendations may be based on one or more of the financial transactions and/or are associated with income-tax deductions.

In some embodiments, the computer system refers the user to a community of users who can assist the user in improving the social responsibility metric. Note that the community of users may be in a region in geographic proximity to the user. Moreover, the community of users may interact via a network.

In some embodiments, the computer system compares the social responsibility metric with those of other users, and provides the comparison to the user.

In some embodiments, the financial software includes income-tax software, payroll software, and/or accounting software.

In some embodiments, the computer system determines an income-tax deduction based on the social responsibility metric. Moreover, the computer system may validate the income-tax deduction based on one or more of the financial transactions.

In some embodiments, the financial transactions include purchases or travel.

Another embodiment provides a user interface (such as a graphical user interface) for providing the social responsibility metric and/or related information to the user.

Another embodiment provides a method for determining the social responsibility metric, which may be performed by the computer system. This method may include at least some of the preceding operations.

Another embodiment provides a computer-program product for use in conjunction with the computer system. This computer-program product may include instructions corresponding to at least some of the preceding operations. Moreover, this computer-program product may be implemented separately from the financial software or may be included in the financial software.

### BRIEF DESCRIPTION OF THE FIGURES

FIG. 1 is a block diagram illustrating a computer system including computers and servers that are networked together in accordance with an embodiment of the present invention.

FIG. 2 is a block diagram illustrating a computer system in accordance with an embodiment of the present invention.

FIG. 3 is a flowchart illustrating a method for determining a social responsibility metric in accordance with an embodiment of the present invention.

FIG. 4A is a block diagram illustrating a screen shot of a user interface in accordance with an embodiment of the present invention.

FIG. 4B is a block diagram illustrating a screen shot of a user interface in accordance with an embodiment of the present invention.

FIG. 5 is a block diagram illustrating a data structure in accordance with an embodiment of the present invention.

Note that like reference numerals refer to corresponding parts throughout the drawings.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of a computer system, a method, a user interface and a computer-program product (i.e., software) for use with the computer system are described. These systems, software, and processes may be used to provide a user with a social responsibility metric that is determined based on one or more financial transactions. In particular, financial transactions associated with a user (such as an individual, an organization, a corporation, a municipality or an entity) may be aggregated to determine the social responsibility metric, which is then provided to the user. In some embodiments, the financial transactions may be included in a data structure that is associated with financial software, such as income-tax software, payroll software, and/or accounting software.

Based on the social responsibility metric, the computer system may: provide recommendations to the user; refer the user to a community of users (for example, users in geographic proximity to the user or users that interact via a network, such as the Internet); compare the social responsibility metric with those of other users; and/or determine an income-tax deduction. These operations may assist the user in improving the social responsibility metric, and thus, increase the social and environmental sustainability of the user's future financial transactions.

For example, the social responsibility metric may include an estimated carbon footprint (and, more generally, an ecological footprint) associated with the financial transactions. Moreover, based on the estimated carbon footprint, the user may purchase a carbon-offset credit (such as those offered in a cap-and-trade system). Additionally, the recommendations may assist the user in deciding which products or services to purchase (or not purchase) in the future.

In the discussion that follows, the social responsibility metric may provide a measure of the social and/or environmental impact of financial transactions, including the impact on other people (and, more generally, on other entities), as well as on the local or global ecosystem. In conjunction with a profit assessment of the financial transactions, these techniques may provide a triple bottom-line assessment for the user (i.e., people, planet, and profit accounting), thereby providing information to the user that facilitates social responsibility and sustainability.

Note that these techniques may be implemented as a stand-alone software application, or as a program module or subroutine in another application, such as the financial software. Furthermore, the software application may be configured to execute on a client computer, such as: a personal computer, a laptop computer, cell phone, PDA, or other device capable of manipulating computer-readable data, or between two or more computing systems over a network (such as the Internet, World Wide Web or Www, intranet, LAN, WAN, MAN, or combination of networks, or other technology enabling communication between computing systems). Therefore, information associated with the time entries may be stored locally (for example, on a local computer) and/or remotely (for example, on a computer or server that is accessed via a network).

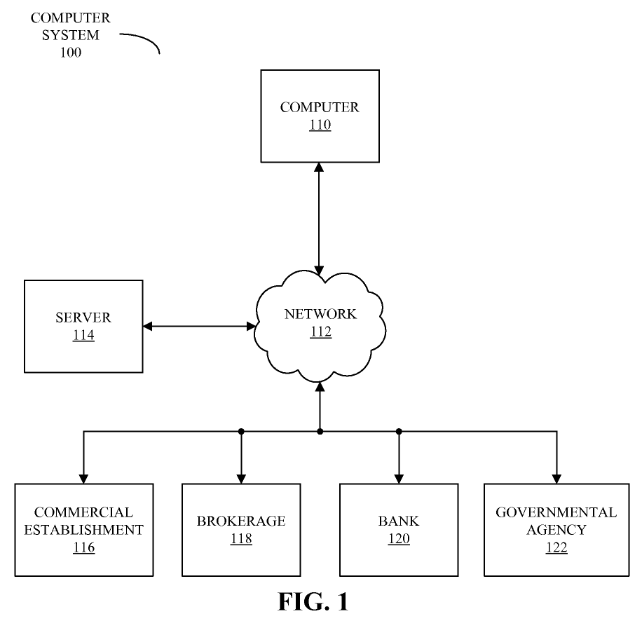

We now describe embodiments of systems, devices and processes for determining a social responsibility metric. FIG. 1 presents a block diagram illustrating a computer system 100, including computers and servers that are networked together. In this computer system, one or more users may use financial software, such as accounting, payroll or income-tax software, to collect information associated with financial transactions, such as the purchase of an article of commerce or a plane ticket, or a power bill (which may include the total bill amount, as well as the amount of one or more types of energy that were used during a time interval). For example, the information may be provided by the user. Alternatively, the financial software may access and retrieve remotely stored information associated with the user and/or the user's accounts via network 112. Note that this information may be associated with: a commercial establishment 116, a brokerage 118, a bank 120 (which may include an online bank), and/or a governmental agency 122 (such as the Internal Revenue Service).

Moreover, a program module or application may aggregate at least some of the information associated with the financial transactions to determine a social responsibility metric for the user. This social responsibility metric may provide qualitative and/or quantitative feedback on the consequences of the user's actions and decisions for other people and/or the environment. For example, the user may be alerted to disreputable labor practices of a supplier of a product that the user has previously purchased. Alternatively, the user's carbon footprint may be estimated. In another example, a widget in a user interface may indicate the user's carbon footprint in a recent or current time interval, with an associated color coding (such as green, yellow or red) to indicate the user's impact on the environment relative to a targeted impact (for example, a goal that the user set or a recommended impact level).

Additionally, the application may assist the user with remedial action. For example, the user may request and/or purchase a carbon-offset credit based on the estimated carbon footprint. More generally, the application may provide recommendations to the user, such as ways to improve the social responsibility metric. The application may also alert the user to their relative performance, by comparing the user's social responsibility metric with those of other users.

In some embodiments, the user may be referred to a community of users, who may reside in geographic proximity to the user or who communicate with each other using network 112. This community, which may include users who share a similar sense of social and/or environmental responsibility, may assist the user in improving the social responsibility metric. (Alternatively, the community may include users who are in the same industry and/or in geographic proximity, who may or may not share the similar sense of social and/or environmental responsibility). For example, the users in the community may recommend alternate suppliers or products, or additional actions the user can take. In the case of the estimated carbon footprint, these actions may include: the use of alternate fuels or modes of transportation, suggestions on ways to reduce the estimated carbon footprint during travel (such as flying non-stop when possible) and/or firms or suppliers that have reduced the estimated carbon footprint associated with their products.

If there are financial incentives offered to encourage socially and/or environmentally responsible behavior, the application may assist the user by: alerting the user to the presence of the financial incentives; determining if the user qualifies for the financial incentives; and/or determining if there are ways the user can increase the financial incentives. For example, the application may determine an income-tax deduction for the user based on the social responsibility metric. Moreover, the application may validate the income-tax deduction based on information associated with one or more of the financial transactions.

As noted above, this financial software may be a stand-alone application or may be embedded in another application. In one embodiment, the financial software includes software such as: TurboTax™ (from Intuit, Inc., of Mountain View, Calif.), TaxCut™ (from H&R Block, Inc., of Kansas City, Mo.), TaxAct™ (from 2^{nd} Story Software, Inc., of Cedar Rapids, Iowa), and/or other software capable of preparing an income-tax return.

Moreover, the financial software may include software such as: QuickBooks™ (from Intuit, Inc., of Mountain View, Calif.), Peachtree Complete™ (from The Sage Group PLC, of Newcastle Upon Tyne, the United Kingdom), MYOB Business Essentials™ (from MYOB US, Inc., of Rockaway, N.J.), NetSuite Small Business Accounting™ (from NetSuite, Inc., of San Mateo, Calif.), Cougar Mountain™ (from Cougar Mountain Software, of Boise, Id.), Microsoft Office Accounting™ (from Microsoft Corporation, of Redmond, Wash.), Simply Accounting™ (from The Sage Group PLC, of Newcastle Upon Tyne, the United Kingdom), CYMA IV Accounting™ (from CYMA Systems, Inc., of Tempe, Ariz.), DacEasy™ (from Sage Software SB, Inc., of Lawrenceville, Ga.), Microsoft Money™ (from Microsoft Corporation, of Redmond, Wash.), FreshBooks™ (from 2ndSite, Inc., of Toronto, Canada), Mint™ (from Mint Software, Inc., of Mountain View, Calif.) and/or other payroll or accounting software capable of processing payroll information. Additionally, in some embodiments the financial software includes software such as: Quicken™ (from Intuit, Inc., of Mountain View, Calif.), Microsoft Money™ (from Microsoft Corporation, of Redmond, Wash.), SplashMoney™ (from SplashData, Inc., of Los Gatos, Calif.), Mvelopes™ (from In2M, Inc., of Draper, Utah), and/or open-source applications such as Gnucash™, PLCash™, Budget™ (from Snowmint Creative Solutions, LLC), and/or other planning software capable of processing financial information.

In some embodiments, the financial software may be resident on the computer 110. However, other embodiments may utilize a financial tool that is embedded in a web page (once again, either as a stand-alone application or as a portion of another application). This web page may be provided by server 114 via network 112. In an illustrative embodiment, the financial tool is a software package written in: JavaScript™ (e.g., the financial tool includes programs or procedures containing JavaScript instructions), ECMAScript (the specification for which is published by the European Computer Manufacturers Association International), VBScript™ (a trademark of Microsoft, Inc.) or any other client-side scripting language. In other words, the embedded financial tool may include programs or procedures containing: JavaScript, ECMAScript instructions, VBScript instructions, or instructions in another programming language suitable for rendering by a browser or another client application on the computer 110.

In embodiments where the financial tool is embedded in a web page or executes in an environment on computer 110, information associated with one or more financial transactions may be temporarily stored on the computer 110. Subsequently, this information may be provided to the server 114 via the network 112. Moreover, the information stored on the server 114 may be periodically synchronized with the information stored on the computer 110.

Because the information associated with the financial transactions, as well as one or more instances of the social responsibility metric, may be sensitive in nature, in some embodiments such information may be encrypted. Additionally, this information may be encrypted when it is communicated over the network 112. For example, communication may utilize a protocol such as HyperText Transfer Protocol Secure (HTTPS).

Note that in some embodiments the computer system 100 includes fewer or additional components. Moreover, two or more components may be combined into a single component, and/or a position of one or more components may be changed.

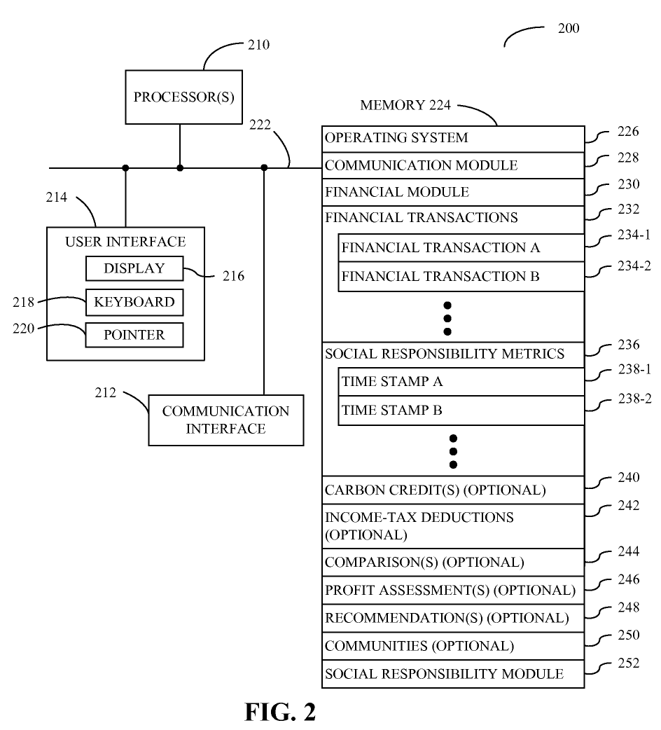

FIG. 2 presents a block diagram illustrating a computer system 200. Computer system 200 includes: one or more processors 210, a communication interface 212, a user interface 214, and one or more signal lines 222 coupling these components together. Note that the one or more processing units 210: may support parallel processing and/or multi-threaded operation, the communication interface 212 may have a persistent communication connection, and the one or more signal lines 222 may constitute a communication bus. Moreover, the user interface 214 may include: a display 216, a keyboard 218, and/or a pointer 220, such as a mouse.

Memory 224 in the computer system 200 may include volatile memory and/or non-volatile memory. More specifically, memory 224 may include: ROM, RAM, EPROM, EEPROM, Flash, one or more smart cards, one or more magnetic disc storage devices, and/or one or more optical storage devices. Memory 224 may store an operating system 226 that includes procedures (or a set of instructions) for handling various basic system services for performing hardware-dependent tasks. While not explicitly indicated in the computer system 200, in some embodiments the operating system 226 includes a web browser. Memory 224 may also store procedures (or a set of instructions) in a communication module 228. These communication procedures may be used for communicating with one or more computers and/or servers, including computers and/or servers that are remotely located with respect to the computer system 200.

Memory 224 may also include multiple program modules (or a set of instructions), including: financial module 230 (or a set of instructions) and/or social responsibility module 252 (or a set of instructions). Financial module 230 may receive information associated with financial transactions 232, such as financial transaction A 234-1 or financial transaction B 234-2. This information may be received from the user and/or may be accessed and retrieved from remote data structures, such as those associated with the user's: bank account(s), brokerage account(s), credit card account(s), income-tax return(s), and/or additional financial records (such as those associated with an entity with which the user conducts financial transactions). Note that the information may be automatically updated. For example, a utility may provide a total bill and/or energy-consumption information (such as kWatt-hours of electricity used) during a time interval.

Social responsibility module 252 may aggregate at least some of the financial transactions 232 and may determine one or more social responsibility metrics 236, such as those associated with the resulting environmental impact or the impact on other people. Note that the social responsibility metrics 236 may be determined as a function of time (such as during different time intervals), which may allow the user to monitor progress. Consequently, the social responsibility metrics 236 may be associated with corresponding time stamps, such as time stamp A 238-1 or time stamp B 238-2.

Furthermore, social responsibility module 252 may assist the user with remedial action that may allow the user to improve one or more of the social responsibility metrics 236. In particular, social responsibility module 252 may provide optional: comparisons 244 with the social responsibility metric(s) of other users (such as an average social responsibility metric of the other users); recommendations 248 on ways to improve one or more of the social responsibility metrics 236; and/or referrals to communities 250 of users, such as a group of users on a network or a group of users who reside in geographic proximity to the user.

Additionally, the social responsibility module 252 or the financial module 230 may determine optional profit assessments 246 associated with one or more of the financial transactions 232, which, in conjunction with the environmental and social impact, provide a triple bottom-line assessment to the user. Moreover, the social responsibility module 252 or the financial module 230 may determine optional income-tax deductions 242 for the user based on one or more of the social responsibility metrics 236. In some embodiments, the social responsibility module 252 or the financial module 230 also validates the optional income-tax deductions 242 for the user based on one or more of the financial transactions 232.

In some embodiments, the user purchases optional carbon credits 240 based on one or more of the social responsibility metrics 236.

Instructions in the various modules in the memory 224 may be implemented in: a high-level procedural language, an object-oriented programming language, and/or in an assembly or machine language. Note that the programming language may be compiled or interpreted, e.g., configurable or configured to be executed by the one or more processing units 210.

Although the computer system 200 is illustrated as having a number of discrete items, FIG. 2 is intended to be a functional description of the various features that may be present in the computer system 200 rather than a structural schematic of the embodiments described herein. In practice, and as recognized by those of ordinary skill in the art, the functions of the computer system 200 may be distributed over a large number of servers or computers, with various groups of the servers or computers performing particular subsets of the functions. In some embodiments, some or all of the functionality of the computer system 200 may be implemented in one or more application specific integrated circuit (ASICs) and/or one or more digital signal processors (DSPs).

Computer system 200 may include fewer components or additional components. Moreover, two or more components may be combined into a single component, and/or a position of one or more components may be changed. In some embodiments, the functionality of the computer system 200 may be implemented more in hardware and less in software, or less in hardware and more in software, as is known in the art.

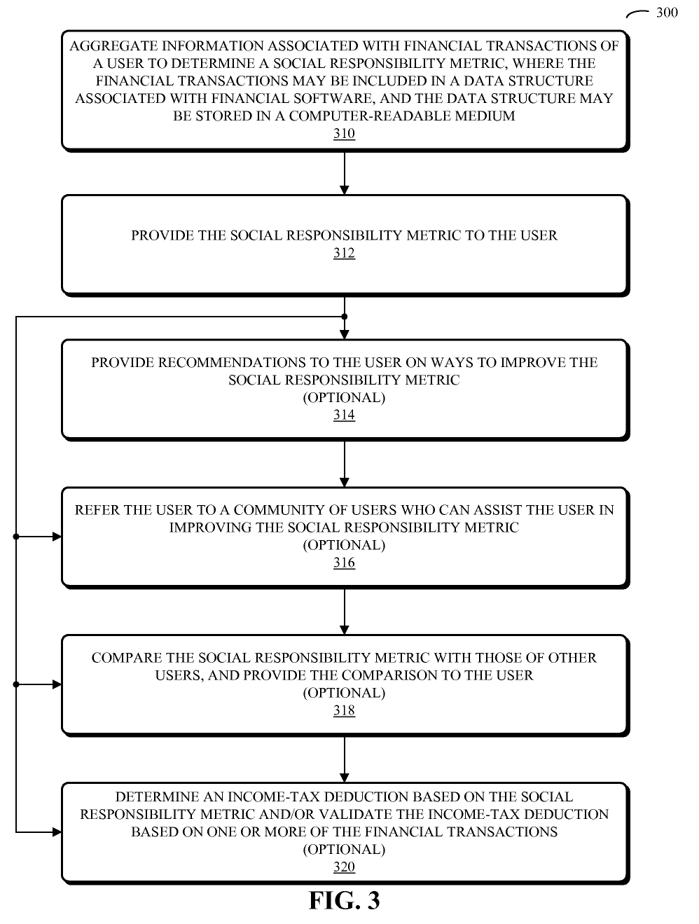

We now describe embodiments of a method for determining a social responsibility metric. FIG. 3 presents a flowchart illustrating a method 300 for determining a social responsibility metric, which may be implemented by a computer system. During operation, the computer system aggregates information associated with financial transactions of a user to determine a social responsibility metric (310), where the financial transactions may be included in a data structure associated with financial software, and the data structure may be stored in a computer-readable medium. Next, the computer system may provide the social responsibility metric to the user (312). For example, the computer system may display the social responsibility metric.

In some embodiments, the computer system provides optional recommendations to the user on ways to improve the social responsibility metric (314). For example, the recommendations may be based on one or more of the financial transactions and/or may be associated with income-tax deductions. Moreover, in some embodiments the computer system optionally refers the user to a community of users who can assist the user in improving the social responsibility metric (316).

Additionally, in some embodiments the computer system optionally compares the social responsibility metric with those of other users, and provides the comparison to the user (318). Moreover, in some embodiments the computer system determines an income-tax deduction based on the social responsibility metric and/or validates the income-tax deduction based on one or more of the financial transactions (320).

Note that in some embodiments of method 300 there may be additional or fewer operations. Moreover, the order of the operations may be changed, and two or more operations may be combined into a single operation.

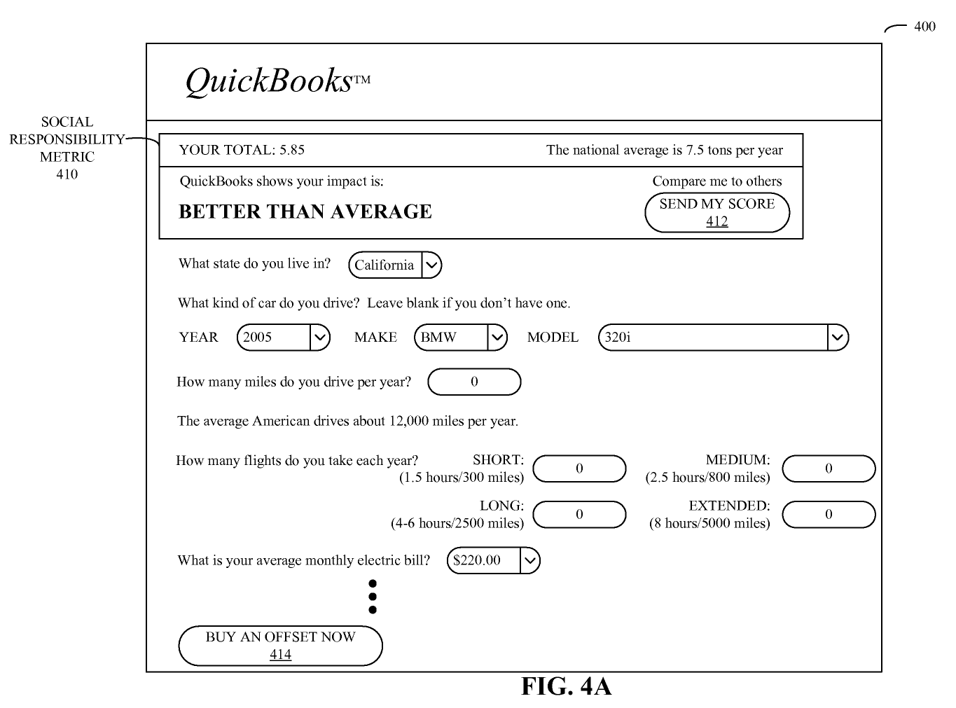

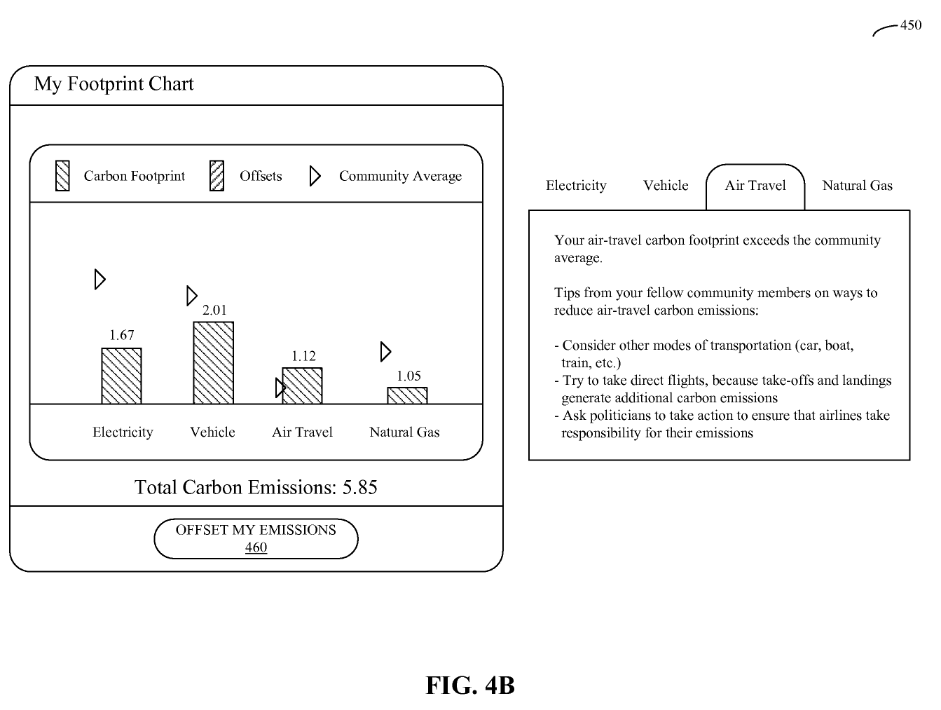

We now describe embodiments of a user interface (such as a graphical user interface) associated with the application that may be used to present information associated with the social responsibility metric to the user. FIG. 4A presents a block diagram illustrating a screen shot of a user interface 400. This user interface includes a people-and-planet assessment tool that provides feedback to a user on the social and/or environmental consequences of the user's financial transactions.

The user may provide information to the application (such as the social responsibility module 252 in FIG. 2) using user interface 400. In particular, the user may answer a series of questions, such as questions about: the user's car, travel (for example, the number of short, medium, long, and extended flights), electric bill, heating-oil bill, natural gas bill, and/or the use of alternative energy sources. Note that the user may select pre-determined answers from pull-down menus or may enter answers in appropriate fields in user interface 400. Alternatively, the application may aggregate at least some of this information based on entries in one or more data structures associated with the financial software. For example, the application may be customized to aggregate information associated with specific financial transactions, such as mileage expenses.

Based on the answers and/or the aggregated information, the application may determine and display social responsibility metric 410 (thus, the social responsibility metric 410 may be a function of the user's car, travel, electric bill, heating-oil bill, natural gas bill, and/or the use of alternative energy sources). Additionally, if the user selects ‘Send My Score’ 412 (for example, by clicking on this icon using a mouse), the application may compare the user's social responsibility metric 410 with those of other users in a community (such as all users of the application) and may display the comparison in user interface 400. In this case, the user's social responsibility metric 410 is better than average.

Moreover, the user may elect to purchase a carbon-offset credit to improve the social responsibility metric 410. For example, the user may select ‘Buy an Offset Now’ 414 by clicking on this icon using a mouse. These credits may be purchased once or on a recurring basis, such as each quarter.

FIG. 4B presents a block diagram illustrating a screen shot of a user interface 450. In this user interface, contributions to the user's estimated carbon footprint are displayed graphically along with community average values. In particular, there are contributions associated with: electricity, vehicle usage, air travel, and natural gas. Additionally, user interface 450 may also display offset contributions. Note that the user may purchase a carbon-offset credit by selecting ‘Offset My Emissions’ 460, for example, by clicking on this icon using a mouse.

In this example, the contribution associated with air travel in the user's estimated carbon footprint exceeds that of the community, such as: the users of the application, or residents of the town or region the user lives in. Moreover, user interface 450 includes recommendations for the user on ways to improve this contribution to the user's estimated carbon footprint.

By comparing the user's social responsibility metric (in this case, the user's estimated carbon footprint) with the average value for the community, the user receives feedback on the consequences of user's actions. Additionally, the user is provided with a variety of remedial actions that the user can take to improve the social responsibility metric.

Moreover, these techniques allow the user to connect with other socially and environmentally minded entities, such as individuals and businesses. For example, users may opt in to a listing service that provides recommendations for so-called ‘green’ suppliers of products. Consequently, these techniques may allow businesses to attract new customers who are looking for socially and/or environmentally responsible products and services.

Note that these techniques may also be used to create a small business sustainability certification. For example, a potential customer may compare the social responsibility metrics of different suppliers or businesses, and may make purchasing decisions accordingly.

In some embodiments, user interfaces 400 (FIG. 4A) and 450 include fewer items or additional items. Moreover, a position of at least one item may be changed and/or two or more items may be combined.

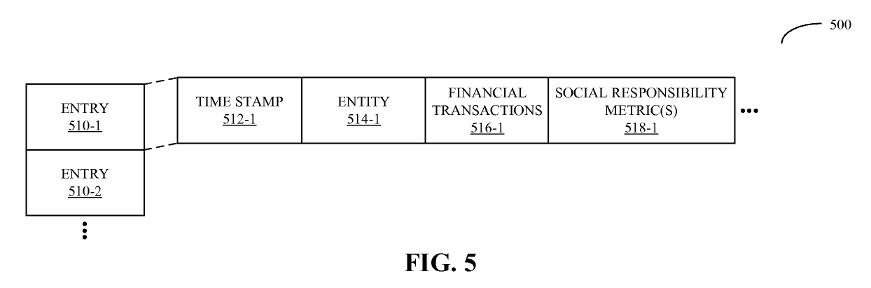

We now discuss embodiments of data structures that may be used in the computer system 100 (FIG. 1) and/or 200 (FIG. 2). FIG. 5 presents a block diagram illustrating a data structure 500. This data structure may include multiple entries 510 with information associated with social responsibility metrics of one or more users of the financial software. For example, entry 510-1 for a user may include: time stamp 512-1, the user or entity 514-1, one or more financial transactions 516-1, and/or one or more social responsibility metrics 518-1.

Note that in some embodiments of the data structure 500 there may be fewer or additional components. Moreover, two or more components may be combined into a single component and/or a position of one or more components may be changed.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for determining a social responsibility metric, comprising:
aggregating information associated with financial transactions of a user to determine the social responsibility metric, wherein the financial transactions are included in a data structure associated with financial software, and wherein the data structure is stored in a computer-readable medium; and
providing the social responsibility metric to the user.

2. The method of claim 1, wherein providing the social responsibility metric to the user involves displaying the social responsibility metric.

3. The method of claim 1, wherein the user includes an individual, an organization, or a corporation.

4. The method of claim 1, wherein the social responsibility metric includes an estimated carbon footprint associated with the financial transactions.

5. The method of claim 4, further comprising receiving a request to purchase a carbon-offset credit based on the estimated carbon footprint.

6. The method of claim 1, wherein the social responsibility metric is based on an impact of the financial transactions on the environment.

7. The method of claim 1, wherein the social responsibility metric is based on an impact of the financial transactions on other people.

8. The method of claim 1, wherein the social responsibility metric is based on a profit assessment of the user.

9. The method of claim 1, further comprising providing recommendations to the user on ways to improve the social responsibility metric.

10. The method of claim 9, wherein the recommendations are based on one or more of the financial transactions.

11. The method of claim 9, wherein the recommendations are associated with income-tax deductions.

12. The method of claim 1, further comprising referring the user to a community of users who can assist the user in improving the social responsibility metric.

13. The method of claim 12, wherein the community of users are in a region in geographic proximity to the user.

14. The method of claim 12, wherein the community of users interact via a network.

15. The method of claim 1, further comprising:
comparing the social responsibility metric with those of other users; and
providing the comparison to the user.

16. The method of claim 1, wherein the financial software includes income-tax software, payroll software, or accounting software.

17. The method of claim 1, further comprising determining an income-tax deduction based on the social responsibility metric.

18. The method of claim 17, further comprising validating the income-tax deduction based on one or more of the financial transactions.

19. The method of claim 1, wherein the financial transactions include purchases or travel.

20. A computer-program product for use in conjunction with a computer system, the computer-program product comprising a computer-readable storage medium and a computer-program mechanism embedded therein for configuring the computer system, the computer-program mechanism including:
instructions for aggregating information associated with financial transactions of a user to determine the social responsibility metric, wherein the financial transactions are included in a data structure associated with financial software, and wherein the data structure is stored in a computer-readable medium; and
instructions for providing the social responsibility metric to the user.

21. The computer-program product of claim 20, wherein the social responsibility metric includes an estimated carbon footprint associated with the financial transactions.

22. The computer-program product of claim 20, wherein the social responsibility metric is based on an impact of the financial transactions on the environment.

23. The computer-program product of claim 20, further comprising providing recommendations to the user on ways to improve the social responsibility metric.

24. The computer-program product of claim 23, wherein the recommendations are associated with income-tax deductions.

25. The computer-program product of claim 20, further comprising:
comparing the social responsibility metric with those of other users; and
providing the comparison to the user.

26. The computer-program product of claim 20, further comprising determining an income-tax deduction based on the social responsibility metric.

27. A computer system, comprising:
a processor;
memory;
a program module, wherein the program module is stored in the memory and configured to be executed by the processor, the program module including:
instructions for aggregating information associated with financial transactions of a user to determine the social responsibility metric, wherein the financial transactions are included in a data structure associated with financial software, and wherein the data structure is stored in a computer-readable medium; and
instructions for providing the social responsibility metric to the user.
